(19) United States
(12) Patent Application Publication
(10) Pub. No.: US 2002/0107748 A1
(43) Pub. Date: Aug. 8, 2002

(54) Method and system for decentralized order matching among individual marketplaces

(75) Inventors: Stephen J. Boies, Mahopac, NY (US); Samuel H. Dinkin, Austin, TX (US); David P. Greene, Ossining, NY (US); William Grey, Millwood, NY (US); Paul A. Moskowitz, Yorktown Heights, NY (US); Philip S. Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/776,990

(22) Filed: Feb. 5, 2001

(51) Int. Cl. G06F 17/60

(52) U.S. Cl. 705/26; 705/8; 705/37

(57) ABSTRACT

A method and system are described for decentralized order matching among multiple different, individual marketplaces. An order is first received within one of the individual marketplaces, an originating marketplace. Information about the order is then transmitted to other individual marketplaces. Each of the individual marketplaces which received the information about the order, the receiving marketplaces, then determines whether that individual marketplace can match the order with at least one matching order posted in the receiving marketplace's order book. In response to a determination that one of the receiving marketplaces can match the received order, the received order is cleared from the originating marketplace and the matching order is cleared from the receiving marketplace's order book.

### CROSS-REFERENCE TO RELATED APPLICATIONS

The present invention is related to the subject matter of co-pending patent application serial number XXXX (Docket Number YOR9-2000-0493-US1) entitled “CENTRALIZED ORDER BOOK SYSTEM AND METHOD”, assigned to the assignee herein named, filed on XXXX and incorporated herein by reference.

### BACKGROUND OF THE INVENTION

1. Technical Field

The present invention relates in general to apparatus and methods for providing decentralized order matching among separate, individual marketplaces. More particularly, the present invention provides apparatus and methods for bilaterally clearing orders among separate, individual marketplaces.

2. Description of Related Art

Individual marketplaces are known for matching and clearing orders. An individual marketplace maintains its own, local order book for clearing orders. A “marketplace” is an entity, such as an auction, which matches buyers and sellers to clear orders. A potential buyer may post a buy order in the local order book. Similarly, a potential seller may post a sell order in the local order book. The individual marketplace is then responsible for attempting to clear these orders by matching them with other orders which are posted in the local order book.

Large marketplaces have the advantage of bringing together greater numbers of buyers and sellers, thus increasing the potential to clear a large number of transactions. This reduces the operating costs of the marketplace, and thus the costs to the buyers and sellers.

In practice, however, multiple marketplaces generally exist for a given set of goods or services, often with different sets of buyers and sellers. This can limit the potential for individual marketplaces to clear a large number of orders.

Therefore, a need exists for a method and system for bilaterally clearing orders from separate, individual marketplaces.

### SUMMARY OF THE INVENTION

A method and system are described for decentralized order matching among multiple different, individual marketplaces. An order is first received within one of the individual marketplaces, an originating marketplace. Information about the order is then transmitted to other individual marketplaces. Each of the individual marketplaces which received the information about the order, the receiving marketplaces, then determines whether that individual marketplace can match the order with at least one matching order posted in the receiving marketplace's order book. In response to a determination that one of the receiving marketplaces can match the received order, the received order is cleared from the originating marketplace and the matching order is cleared from the receiving marketplace's order book.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating a distributed data processing system according to the present invention;

FIG. 2 is an exemplary block diagram of a server according to the present invention;

FIG. 3 is an exemplary block diagram of a client according to the present invention;

FIG. 4 illustrates a high level flow chart which depicts establishing a prioritized list of preferred providers for an individual marketplace in accordance with the present invention;

FIG. 5 depicts a high level flow chart which illustrates an individual marketplace receiving an order from a customer and attempting to clear the order utilizing other individual marketplaces in accordance with the present invention; and

FIG. 6 illustrates a high level flow chart which depicts an individual marketplace attempting to clear orders received from another individual marketplace in accordance with the present invention.

### DETAILED DESCRIPTION OF THE PREFERRED EMBODIMENT

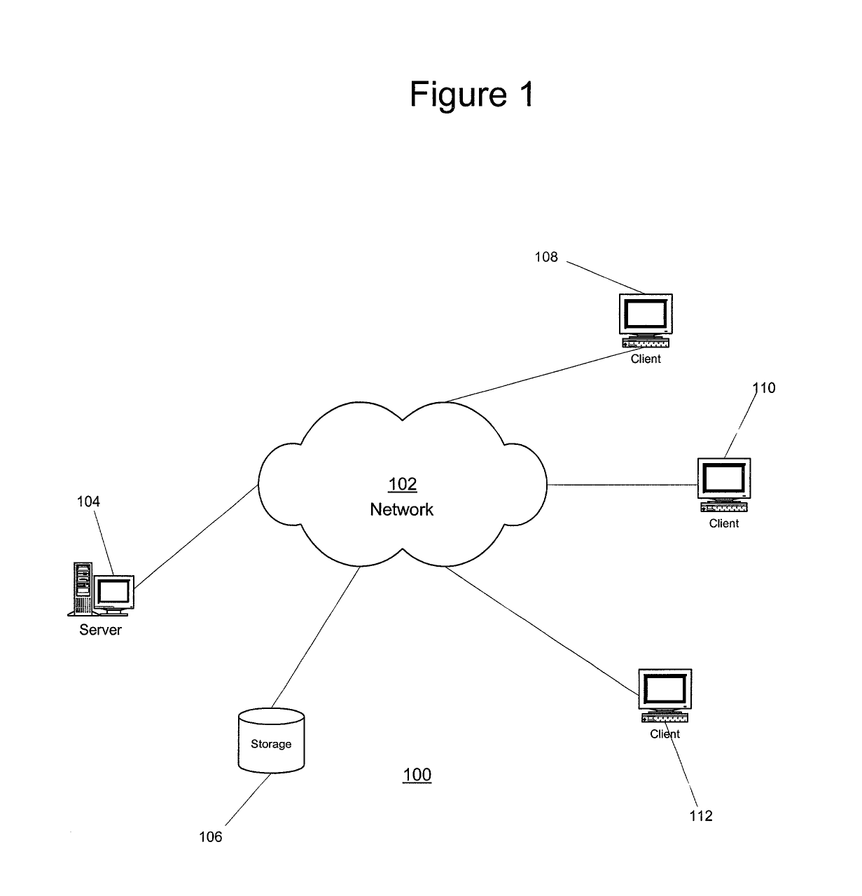

A preferred embodiment of the present invention and its advantages are better understood by referring to FIGS. 1-6 of the drawings, like numerals being used for like and corresponding parts of the accompanying drawings.

The invention is preferably realized using a well-known computing platform, such as an IBM RS/6000 workstation running the IBM AIX operating system. However, it may be realized in other popular computer system platforms, such as an IBM personal computer running the Microsoft Windows operating system or a Sun Microsystems workstation running alternate operating systems such as UNIX or LINUX, without departing from the spirit and scope of the invention.

The present invention is a method and system for decentralized order matching among separate, individual marketplaces. An order is first received and posted in a local order book of one of the individual marketplaces, called an originating marketplace. Information about the order is then transmitted from the originating marketplace to other marketplaces, called receiving marketplaces. Each of the receiving marketplaces then determines whether it can match the received order with one or more matching orders posted in the receiving marketplace's local order book. In response to a determination that one of the receiving marketplaces can match the received order, the received order is cleared from the originating marketplace's order book and the matching order(s) are cleared from the order book of the receiving marketplace.

An order book attempts to match a posted order with a “best” matching order. The order book may utilize any known method for determining which order is a “best” matching order. In addition, the marketplaces may all use the same method, or the marketplaces may each use a different method for determining matches.

In some cases the “best” matching order is actually a combination of orders. In these cases, the “best” matching order is more than one order. For example, a buyer may post an order to buy five cars of a particular model at $20,000 each. This order may be matched with one order to sell two of this car model at $18,000 with another order to sell six of this model at $19,000. The “best” match for the buy order is two cars at $18,000 each and three cars at $19,000 each.

A “best” matching order may be determined using the price of an order, its queue position, the identity of the originating marketplace, and/or any other suitable criteria.

As an order is posted in the local order book of each individual marketplace, the individual marketplace first attempts to clear the order locally using the marketplace's own, local order book. If the originating marketplace cannot clear the order locally, the originating marketplace then transmits information about the order to other, different marketplaces.

Preferred provider marketplaces may be specified for a particular marketplace. The preferred providers also may be prioritized. When preferred providers exist and when the marketplace is unable to match an order using its own, local order book, the marketplace will first transmit information about the received order to the preferred providers, according to an existing priority scheme. If none of the specified preferred providers can match the received order, the originating marketplace will transmit information about the order to all of the remaining marketplaces.

The originating marketplace may then receive information about one or more matching orders from one or more other marketplaces. The originating marketplace may then screen out matching orders from non-approved marketplaces. The originating marketplace may then select a best order from the remaining matching orders. The originating marketplace will then transmit a notice to the other marketplace which specifies the selected order. The originating marketplace will then wait for a confirmation. If a confirmation is received from the other marketplace, the originating marketplace will clear the order from its local order book. If the originating marketplace does not receive a confirmation, the originating marketplace will then remove this selected order from the matching orders and select a best matching order from any remaining orders. If no matching orders are reported to the originating marketplace, the originating marketplace will unlock the order in its local order book.

When a receiving marketplace is able to match an order, the receiving marketplace will select all orders posted in its local order book which match the product of the received order. All of the selected orders are then locked. The receiving marketplace will then transmit information about each of the selected orders to the originating marketplace. If the receiving marketplace receives a specification of one of these orders, the receiving marketplace will unlock all of the selected, locked orders and clear the order in its local order book which was specified. The receiving marketplace will then transmit a confirmation to the originating marketplace that the order(s) were cleared. If the receiving marketplace does not receive a specification of an order, the receiving marketplace will then unlock all selected orders.

In the preferred embodiment, the various individual marketplaces exist within computer systems which are coupled to each other using a network, such as the Internet. These marketplaces may exist within a single computer system, but are typically each implemented in different computer systems.

The individual marketplaces are entities which are capable of matching buyers and sellers. In a preferred embodiment, these marketplaces are auctions, typically Internet auction sites. The individual marketplaces may be any combination of one or more types of auctions, such as reverse auctions, multi-sided auctions, and/or call auctions.

In the preferred embodiment, each marketplace is an on-line auction site maintained on a computer system which is coupled to the Internet. Potential buyers and sellers are permitted to access the auction site and post their orders. The auction site then matches buyers and sellers in order to clear orders.

With reference now to the figures, and in particular with reference to FIG. 1, a pictorial representation of a distributed data processing system is depicted in which the present invention may be implemented. Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers, network computers, personal digital assistants, data network compatible cellular devices, cable or satellite TV set-top boxes, Internet ready game consoles, and the like. For purposes of this application, a network computer is any computer coupled to a network which receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network. FIG. 1 is intended as an example and not as an architectural limitation for the processes of the present invention.

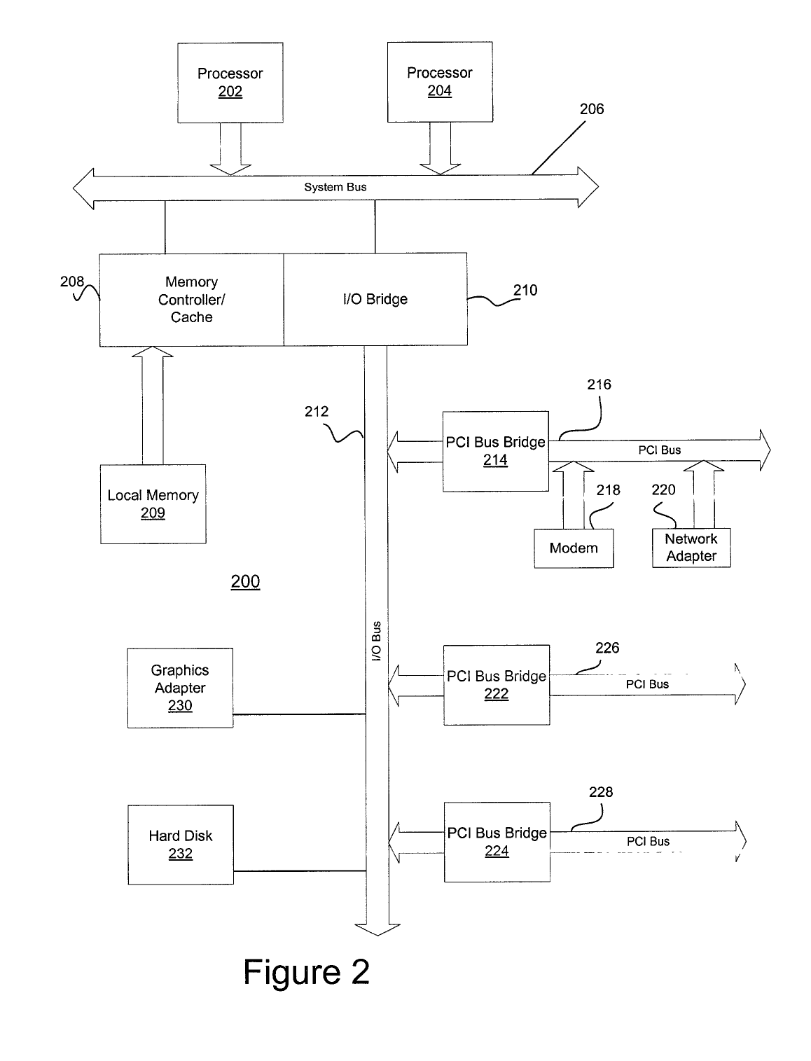

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards. Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000, a product of International Business Machines Corporation in Armonk, N.Y., running the Advanced Interactive Executive (AIX) operating system.

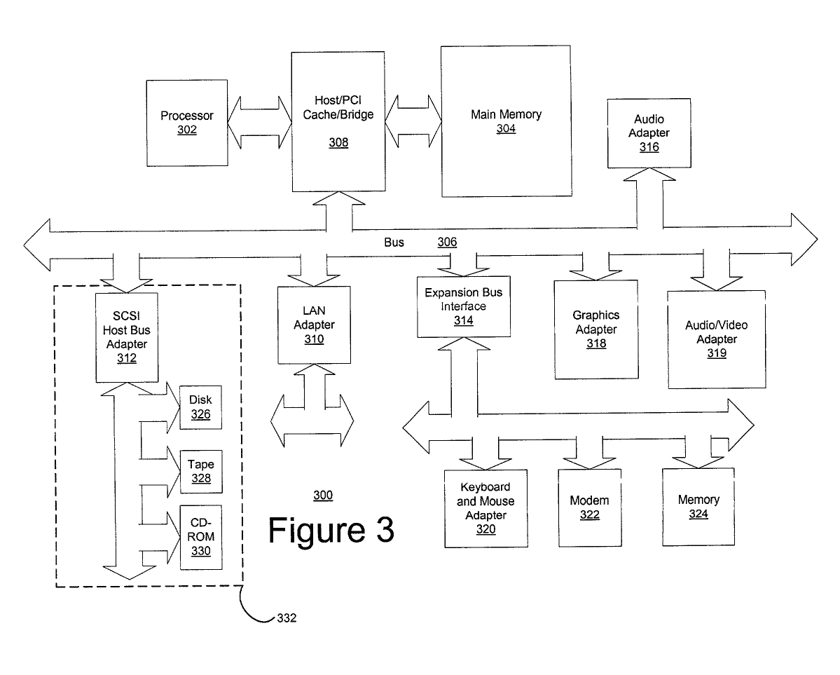

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used.

Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection.

In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324.

In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. Windows is a trademark of Microsoft Corporation.

An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

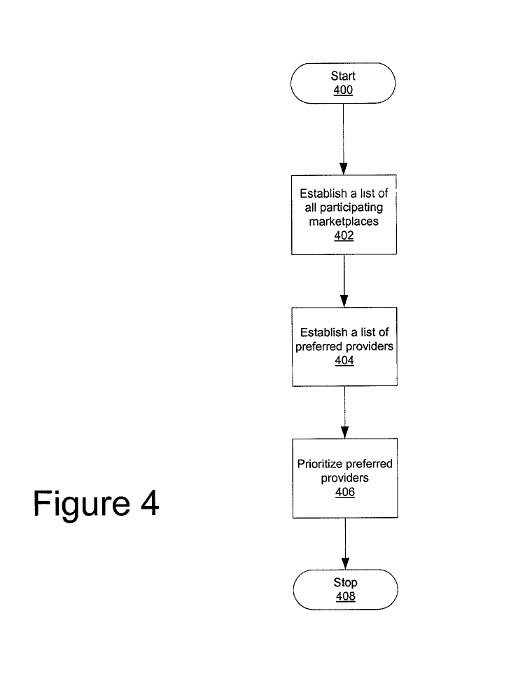

FIG. 4 illustrates a high level flow chart which depicts establishing a prioritized list of preferred providers for an individual marketplace in accordance with the present invention. The process starts as depicted by block 400 and thereafter passes to block 402 which illustrates establishing a list of all participating marketplaces. These are the marketplaces with which an individual marketplace may attempt to bilaterally clear orders. Next, block 404 depicts establishing a list of preferred providers. These are providers selected from the list of all participating marketplaces with which an individual marketplace prefers to conduct business. Thereafter, block 406 illustrates the individual marketplace prioritizing the preferred providers. The process then terminates as depicted by block 408.

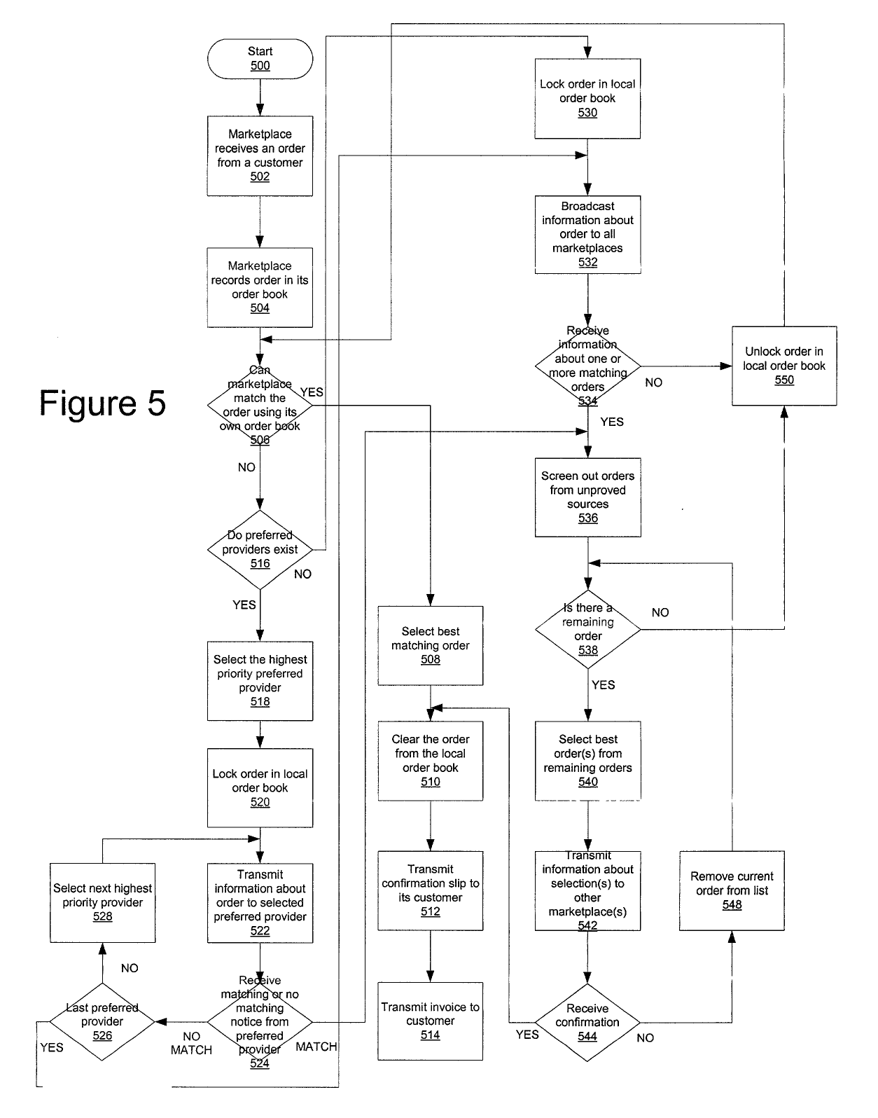

FIG. 5 illustrates a high level flow chart which illustrates an individual marketplace receiving an order from a customer and attempting to clear the order utilizing other individual marketplaces in accordance with the present invention. The process starts as depicted by block 500 and thereafter passes to block 502 which illustrates an individual marketplace site receiving an order from a customer. Next, block 504 depicts an individual marketplace recording the order in that individual marketplace's local order book. Thereafter, block 506 illustrates a determination of whether or not the individual marketplace can match the order using its own, local order book. If a determination is made that the individual marketplace can match the order using its own order book, the process passes to block 508 which depicts the individual marketplace selecting the best matching order from its own local order book.

Block 510, then, illustrates the individual marketplace clearing the order and then removing it from the individual marketplace's order book. Thereafter, block 512 depicts the individual order book transmitting a confirmation slip to its customer. Next, block 514 illustrates the individual marketplace transmitting an invoice to its customer.

Referring again to block 506, if a determination is made that the individual marketplace cannot clear the order using its own local order book, the process passes to block 516 which depicts a determination of whether or not the individual marketplace has specified a list of preferred providers. If a determination is made that the individual marketplace has not specified any preferred providers, the process passes to block 530.

Referring again to block 516, if a determination is made that the individual marketplace has specified preferred providers, the process passes to block 518 which illustrates a selection of the highest priority preferred provider. Next, block 520 depicts the individual marketplace locking its order in its local order book. Thereafter, block 522 illustrates the individual marketplace transmitting information about the order to the selected preferred provider. Block 524, then, depicts a determination of whether or not the marketplace received a notice that the preferred provider was able to match the order in the preferred provider's order book or a notice that the preferred provider was not able to match the order in the preferred provider's order book. In response to a determination that the marketplace received a notice from the preferred provider that it was not able to match the order, the process passes to block 526 which depicts a determination of whether or not there are any more preferred providers. If a determination is made that there are more preferred providers, the process passes to block 528 which illustrates a selection of a next highest priority provider. Thereafter, the process passes back to block 522. Referring again to block 526, if a determination is made that there are no more preferred providers, the process passes to block 532.

Referring again to block 524, if a determination is made that the marketplace received a notice from the preferred provider that the preferred provider was able to match the order in the preferred provider's order book, the process passes to block 536.

Referring again to block 530, block 530 depicts the local marketplace locking the order in its local order book. Next, block 532 illustrates the local marketplace broadcasting information about the order to all participating marketplaces. Block 534, then, depicts a determination of whether or not the local marketplace received information about one or more matching orders from one or more other marketplaces that the other marketplace was able to match the order. If a determination is made that the local marketplace did not receive information about any matching orders, the process passes to block 550 which illustrates the local marketplace unlocking the order in its local order book. The process then passes to block 506. Referring again to block 534, if a determination is made that the local marketplace did receive information about one or more matching orders from one or more other marketplaces, the process passes to block 536.

Block 536 depicts the local marketplace screening out all orders from unapproved sources. Whether or not a source is approved may be based on whether the source is designated as a preferred provider, whether the source maintains a particular credit rating, and/or whether the source maintains a particular quality rating. As another example, an individual marketplace might not want to transact business with one of its competitors. Next, block 538 illustrates a determination of whether or not there are any remaining matching orders. If a determination is made that there are no remaining matching orders, the process passes to block 550.

Referring again to block 538, if a determination is made that there is at least one remaining matching order, the process passes to block 540 which illustrates the marketplace selecting one or more best orders from the remaining orders. The process then passes to block 542 which depicts this local marketplace transmitting information about these selected one or more orders to the originating marketplaces. For example, if the local marketplace received a notice of a matching order from another marketplace, the local marketplace will transmit information about a selection of this order to the other marketplace. If the local marketplace received a notice of a matching order from more than one other marketplace, and if the local marketplace chose multiple orders, the local marketplace will transmit information about a selection of these orders to the other marketplaces.

Next, block 544 depicts a determination of whether or not the local marketplace received a confirmation from each marketplace to which a selection was transmitted. If a determination is made that the local marketplace did receive a confirmation from each marketplace to which information about a selection was transmitted, the process passes to block 510.

Referring again to block 544, if a determination is made that the local marketplace has not received a confirmation from each marketplace to which information about a selection was transmitted, the process passes to block 548 which depicts the local marketplace removing the information about this order from the remaining matching orders. The process passes to block 538.

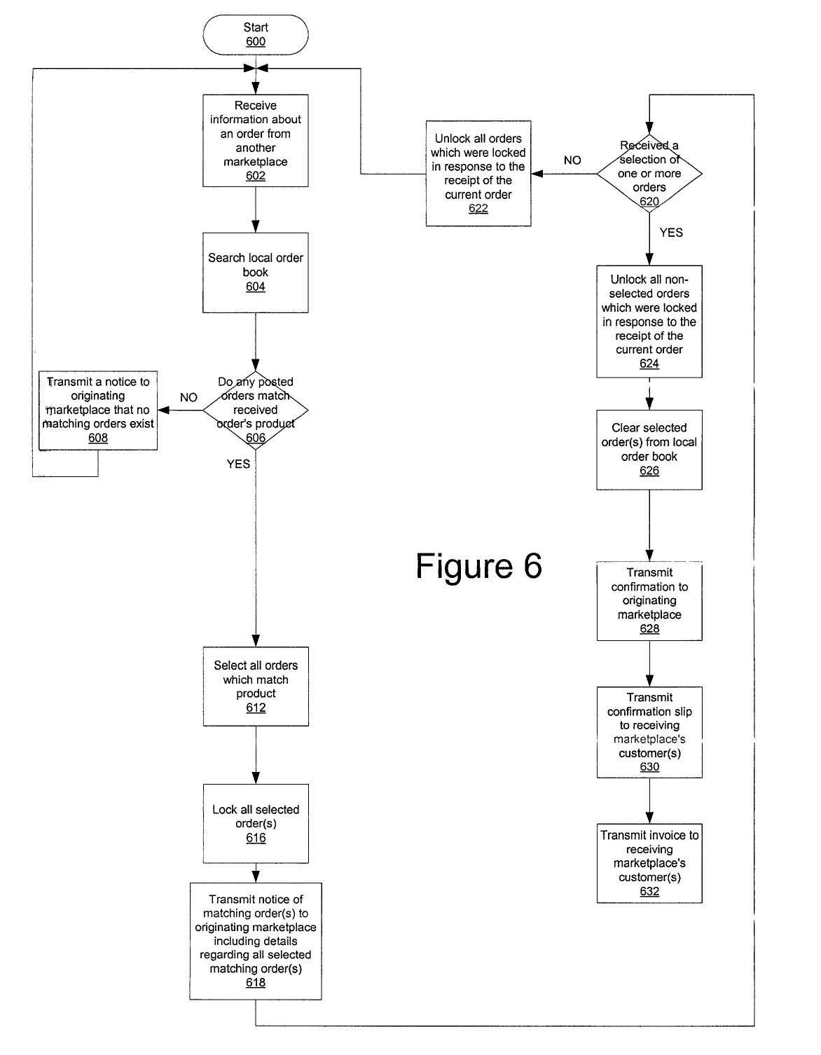

FIG. 6 illustrates a high level flow chart which depicts an individual marketplace attempting to clear orders received from another individual marketplace in accordance with the present invention. The process starts as depicted by block 600 and thereafter passes to block 602 which illustrates a receiving marketplace receiving information about an order from an originating marketplace. Next, block 604 depicts the receiving marketplace searching its local order book for one or more matching orders. The process then passes to block 606 which illustrates a determination of whether or not the receiving marketplace found any orders posted in its local order book which match the received order's product. If a determination is made that there are no orders posted in the receiving marketplace's local order book which match the received order's product, the process passes to block 608 which depicts this marketplace transmitting a notice to the originating marketplace where the received order originated that no matching orders exist. The process then passes to block 602.

Referring again to block 606, if a determination is made that there is at least one order in the receiving marketplace's local order book which matches the received order's product, the process passes to block 612 which illustrates the receiving marketplace selecting all orders in its local order book which match the requested product. Thereafter, block 616 depicts the receiving marketplace's local order book locking all of the selected orders. Next, block 618 illustrates the local order book transmitting a notice to the originating marketplace including details for each selected matching order. The process then passes to block 620 which depicts a determination of whether or not the receiving marketplace received a selection of one or more orders. If a determination is made that the receiving marketplace did not receive a selection of one or more orders, the process passes to block 622 which illustrates the receiving marketplace unlocking all orders which were locked in response to the receipt of this current order. The process then passes back to block 602.

Referring again to block 620, if a determination is made that the receiving marketplace did receive a selection of one or more orders, the process passes to block 624 which depicts the receiving marketplace unlocking all non-selected orders which were locked in response to receipt of this current order. The selected orders remain locked. Next, block 626 illustrates the receiving marketplace clearing the selected order(s) from the receiving marketplace's local order book. Thereafter, block 628 depicts the receiving marketplace transmitting a confirmation to the originating marketplace where the current order originated that the receiving marketplace did clear the order. Block 630, then, illustrates the receiving marketplace transmitting a confirmation slip to the receiving marketplace's customer. Next, block 632 depicts the receiving marketplace transmitting an invoice to its customer.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for decentralized order matching among a plurality of separate, individual marketplaces, said method comprising the steps of:
receiving an order within a first one of said plurality of different individual marketplaces;
transmitting information about said received order to other ones of said plurality of marketplaces;
determining, within each of said other ones of said plurality of marketplaces which received said information about said received order, whether said other one of said plurality of marketplaces can match said received order with at least one matching order posted in a local order book maintained by said other one of said plurality of marketplaces; and
in response to a determination that said other one of said plurality of marketplaces can match said received order, clearing said received order from said first one of said plurality of marketplaces and said at least one matching order posted in said local order book maintained by said other one of said plurality of marketplaces.

2. The method according to claim 1, further comprising the step of prior to transmitting said information about said received order to other ones of said plurality of marketplaces, locking said received order in said first one of said plurality of marketplaces, wherein said received order cannot be modified while said received order is locked.

3. The method according to claim 1, further comprising the steps of:
specifying a plurality of preferred ones of said plurality of marketplaces;
transmitting information about said received order first to only said plurality of preferred ones of said plurality of marketplaces;
determining whether any of said plurality of preferred ones of said plurality of marketplaces can match said received order with at least one matching order posted in a local order book maintained by one of said plurality of preferred ones of said plurality of marketplaces; and
in response to a determination that at least one of said plurality of preferred ones of said plurality of marketplaces can match said received order, clearing said received order from said first one of said plurality of marketplaces and said at least one matching order posted in said local order book maintained by said at least one of said plurality of preferred ones of said plurality of marketplaces.

4. The method according to claim 3, further comprising the step of in response to a determination that none of said plurality of preferred ones of said plurality of marketplaces can match said received order, transmitting said received order to ones of said plurality of marketplaces which are not said plurality of preferred ones of said plurality of marketplaces.

5. The method according to claim 1, further comprising the steps of:
determining, within a plurality of said other ones of said plurality of marketplaces which received said received order, that said plurality of said other ones of said plurality of marketplaces can match said received order with a matching order posted in a local order book maintained by each of said plurality of said other ones of said plurality of marketplaces;
receiving, within said first one of said plurality of marketplaces, information about a plurality of matching orders, said plurality of matching orders including information about said matching order posted in said local order book maintained by each of said plurality of said other ones of said plurality of marketplaces; and
selecting a best order from said plurality of matching orders.

6. The method according to claim 5, further comprising the step of screening orders from non-approved ones of said plurality of marketplaces, wherein orders from non-approved marketplaces are not included in said plurality of matching orders.

7. The method according to claim 5, further comprising the step of transmitting a notice to one of said plurality of marketplaces where said best order is posted.

8. The method according to claim 7, further comprising the step of receiving a confirmation from said one of said plurality of marketplaces where said best order is posted that said best order has been cleared from a local order book maintained by said one of said plurality of marketplaces where said best order is posted.

9. The method according to claim 8, further comprising the step of clearing said received order from said first one of said plurality of marketplaces only in response to a receipt of said confirmation.

10. The method according to claim 9, further comprising the step of unlocking said received order in said first one of said plurality of marketplaces in response to a receipt of said confirmation.

11. The method according to claim 8, further comprising the step of unlocking said received order in said first one of said plurality of marketplaces in response to a determination that none of said other ones of said plurality of marketplaces can match said received order.

12. The method according to claim 7, further comprising the step of receiving a notice from said one of said plurality of marketplaces where said best order is posted that said best order cannot be cleared from a local order book maintained by said one of said plurality of marketplaces where said best order is posted;
removing said best order from plurality of matching orders; and
selecting another order from remaining ones of said plurality of matching orders.

13. The method according to claim 1, further comprising the steps of:
in response to a second one of said plurality of marketplaces receiving said information about said received order from said first one of said plurality of marketplaces, said second one determining whether said second one can match said received order with at least one order posted in a local order book maintained by said second one of said plurality of marketplaces; and
in response to a determination that said second one of said plurality of marketplaces cannot match said received order, said second one of said plurality of marketplaces transmitting a notice to said first one of said plurality of marketplaces that no match exists.

14. The method according to claim 1, further comprising the steps of:
in response to a second one of said plurality of marketplaces receiving said information about said received order from said first one of said plurality of marketplaces, said second one determining whether said second one can match said received order with at least one order posted in a local order book maintained by said second one of said plurality of marketplaces; and
in response to a determination that said second one of said plurality of marketplaces can match said received order, said second one selecting all orders posted in said second one's local order book which match a product requested by said received order;
said second one locking all of said selected orders; and
said second one transmitting a notice to said first one, said notice including information about all of said selected orders.

15. The method according to claim 14, further comprising the steps of:
said first one transmitting a specification of at least one of said selected orders to said second one;
in response to said second one has receiving a specification from said first one of said at least one of said selected orders:
unlocking all of said selected orders;
clearing said at least one of said selected orders specified by said first one; and
said second one transmitting a confirmation to said first one that said at least one of said selected orders has been cleared.

16. The method according to claim 1, wherein said plurality of marketplaces includes a plurality of different individual on-line auction sites.

17. The method according to claim 1, wherein the step of receiving an order further comprises the step of receiving an auction bid.

18. The method according to claim 1, wherein the step of receiving an order further comprises the step of receiving a reverse auction bid.

19. The method according to claim 1, wherein the step of receiving an order further comprises the step of receiving a multi-sided auction bid.

20. The method according to claim 1, wherein the step of receiving an order further comprises the step of receiving a call auction bid.

21. The method according to claim 1, further comprising the step of establishing each one of said plurality of marketplaces in a different computer system.

22. The method according to claim 1, further comprising the step of establishing each one of said plurality of marketplaces in a different one of a plurality of computer systems, wherein said plurality of computer systems are coupled together utilizing the Internet.

23. A system for decentralized order matching among a plurality of separate, individual marketplaces, comprising:
an order being received within a first one of said plurality of different individual marketplaces;
information about said received order being transmitted to other ones of said plurality of marketplaces;
each of said other ones of said plurality of marketplaces which received said information about said received order for determining whether said other one of said plurality of marketplaces can match said received order with at least one matching order posted in a local order book maintained by said other one of said plurality of marketplaces; and
said received order being cleared from said first one of said plurality of marketplaces and said at least one matching order posted in said local order book maintained by said other one of said plurality of marketplaces in response to a determination that said other one of said plurality of marketplaces can match said received order.

24. The system according to claim 23, further comprising said received order being locked in said first one of said plurality of marketplaces prior to transmitting said information about said received order to other ones of said plurality of marketplaces, wherein said received order cannot be modified while said received order is locked.

25. The system according to claim 23, further comprising:
a plurality of preferred ones of said plurality of marketplaces being specified;
information about said received order being transmitted first to only said plurality of preferred ones of said plurality of marketplaces;
means for determining whether any of said plurality of preferred ones of said plurality of marketplaces can match said received order with at least one matching order posted in a local order book maintained by one of said plurality of preferred ones of said plurality of marketplaces; and
said received order being cleared from said first one of said plurality of marketplaces and said at least one matching order posted in said local order book maintained by said at least one of said plurality of preferred ones of said plurality of marketplaces in response to a determination that at least one of said plurality of preferred ones of said plurality of marketplaces can match said received order.

26. The system according to claim 25, further comprising said received order being transmitted to ones of said plurality of marketplaces which are not said plurality of preferred ones of said plurality of marketplaces in response to a determination that none of said plurality of preferred ones of said plurality of marketplaces can match said received order.

27. The system according to claim 23, further comprising:
a plurality of said other ones of said plurality of marketplaces which received said received order for determining that said plurality of said other ones of said plurality of marketplaces can match said received order with a matching order posted in a local order book maintained by each of said plurality of said other ones of said plurality of marketplaces;
said first one of said plurality of marketplaces for receiving information about a plurality of matching orders, said plurality of matching orders including information about said matching order posted in said local order book maintained by each of said plurality of said other ones of said plurality of marketplaces; and
a best order being selected from said plurality of matching orders.

28. The system according to claim 27, further comprising orders being screened from non-approved ones of said plurality of marketplaces, wherein orders from non-approved marketplaces are not included in said plurality of matching orders.

29. The system according to claim 27, further comprising a notice being transmitted to one of said plurality of marketplaces where said best order is posted.

30. The system according to claim 29, further comprising a confirmation being received from said one of said plurality of marketplaces where said best order is posted that said best order has been cleared from a local order book maintained by said one of said plurality of marketplaces where said best order is posted.

31. The system according to claim 30, further comprising said received order being cleared from said first one of said plurality of marketplaces only in response to a receipt of said confirmation.

32. The system according to claim 31, further comprising said received order being unlocked in said first one of said plurality of marketplaces in response to a receipt of said confirmation.

33. The system according to claim 30, further comprising said received order being unlocked in said first one of said plurality of marketplaces in response to a determination that none of said other ones of said plurality of marketplaces can match said received order.

34. The system according to claim 29, further comprising a notice being received from said one of said plurality of marketplaces where said best order is posted that said best order cannot be cleared from a local order book maintained by said one of said plurality of marketplaces where said best order is posted;
said best order being removed from plurality of matching orders; and
another order being selected from remaining ones of said plurality of matching orders.

35. The system according to claim 23, further comprising the steps of:
said second one for determining whether said second one can match said received order with at least one order posted in a local order book maintained by said second one of said plurality of marketplaces in response to a second one of said plurality of marketplaces receiving said information about said received order from said first one of said plurality of marketplaces; and
said second one of said plurality of marketplaces for transmitting a notice to said first one of said plurality of marketplaces that no match exists in response to a second one of said plurality of marketplaces receiving said information about said received order from said first one of said plurality of marketplaces.

36. The system according to claim 23, further comprising:
said second one for determining whether said second one can match said received order with at least one order posted in a local order book maintained by said second one of said plurality of marketplaces in response to a second one of said plurality of marketplaces receiving said information about said received order from said first one of said plurality of marketplaces; and
said second one for selecting all orders posted in said second one's local order book which match a product requested by said received order in response to a second one of said plurality of marketplaces receiving said information about said received order from said first one of said plurality of marketplaces;
said second one for locking all of said selected orders; and
said second one for transmitting a notice to said first one, said notice including information about all of said selected orders.

37. The system according to claim 36, further comprising:
said first one for transmitting a specification of at least one of said selected orders to said second one;
in response to said second one has receiving a specification from said first one of said at least one of said selected orders:
said second one for unlocking all of said selected orders;
said second one for clearing said at least one of said selected orders specified by said first one; and
said second one for transmitting a confirmation to said first one that said at least one of said selected orders has been cleared.

38. The system according to claim 23, wherein said plurality of marketplaces includes a plurality of different individual on-line auction sites.

39. The system according to claim 23, wherein an order being received further comprises an auction bid being received.

40. The system according to claim 23, wherein an order being received further comprises a reverse auction bid being received.

41. The system according to claim 23, wherein an order being received further comprises a multi-sided auction bid being received.

42. The system according to claim 23, wherein an order being received further comprises a call auction bid being received.

43. The system according to claim 23, further comprising each one of said plurality of marketplaces being established in a different computer system.

44. The system according to claim 23, further comprising each one of said plurality of marketplaces being established in a different one of a plurality of computer systems, wherein said plurality of computer systems are coupled together utilizing the Internet.

45. A computer program product for decentralized order matching among a plurality of separate, individual marketplaces, said computer program product comprising:
instruction means for receiving an order within a first one of said plurality of different individual marketplaces;
instruction means for transmitting information about said received order to other ones of said plurality of marketplaces;
instruction means for determining, within each of said other ones of said plurality of marketplaces which received said information about said received order, whether said other one of said plurality of marketplaces can match said received order with at least one matching order posted in a local order book maintained by said other one of said plurality of marketplaces; and
instruction means for in response to a determination that said other one of said plurality of marketplaces can match said received order, clearing said received order from said first one of said plurality of marketplaces and said at least one matching order posted in said local order book maintained by said other one of said plurality of marketplaces.

46. The product according to claim 45, further comprising instruction means for prior to transmitting said information about said received order to other ones of said plurality of marketplaces, locking said received order in said first one of said plurality of marketplaces, wherein said received order cannot be modified while said received order is locked.

47. The product according to claim 45, further comprising:
instruction means for specifying a plurality of preferred ones of said plurality of marketplaces;
instruction means for transmitting information about said received order first to only said plurality of preferred ones of said plurality of marketplaces;
instruction means for determining whether any of said plurality of preferred ones of said plurality of marketplaces can match said received order with at least one matching order posted in a local order book maintained by one of said plurality of preferred ones of said plurality of marketplaces; and
instruction means for in response to a determination that at least one of said plurality of preferred ones of said plurality of marketplaces can match said received order, clearing said received order from said first one of said plurality of marketplaces and said at least one matching order posted in said local order book maintained by said at least one of said plurality of preferred ones of said plurality of marketplaces.

48. The product according to claim 47, further comprising instruction means for in response to a determination that none of said plurality of preferred ones of said plurality of marketplaces can match said received order, transmitting said received order to ones of said plurality of marketplaces which are not said plurality of preferred ones of said plurality of marketplaces.

49. The product according to claim 45, further comprising:
instruction means for determining, within a plurality of said other ones of said plurality of marketplaces which received said received order, that said plurality of said other ones of said plurality of marketplaces can match said received order with a matching order posted in a local order book maintained by each of said plurality of said other ones of said plurality of marketplaces;
instruction means for receiving, within said first one of said plurality of marketplaces, information about a plurality of matching orders, said plurality of matching orders including information about said matching order posted in said local order book maintained by each of said plurality of said other ones of said plurality of marketplaces; and
instruction means for selecting a best order from said plurality of matching orders.

50. The product according to claim 49, further comprising instruction means for screening orders from non-approved ones of said plurality of marketplaces, wherein orders from non-approved marketplaces are not included in said plurality of matching orders.

51. The product according to claim 49, further comprising instruction means for transmitting a notice to one of said plurality of marketplaces where said best order is posted.

52. The product according to claim 51, further comprising instruction means for receiving a confirmation from said one of said plurality of marketplaces where said best order is posted that said best order has been cleared from a local order book maintained by said one of said plurality of marketplaces where said best order is posted.

53. The product according to claim 52, further comprising instruction means for clearing said received order from said first one of said plurality of marketplaces only in response to a receipt of said confirmation.

54. The product according to claim 53, further comprising instruction means for unlocking said received order in said first one of said plurality of marketplaces in response to a receipt of said confirmation.

55. The product according to claim 52, further comprising instruction means for unlocking said received order in said first one of said plurality of marketplaces in response to a determination that none of said other ones of said plurality of marketplaces can match said received order.

56. The product according to claim 51, further comprising:
instruction means for receiving a notice from said one of said plurality of marketplaces where said best order is posted that said best order cannot be cleared from a local order book maintained by said one of said plurality of marketplaces where said best order is posted;
instruction means for removing said best order from plurality of matching orders; and
instruction means for selecting another order from remaining ones of said plurality of matching orders.

57. The product according to claim 45, further comprising:
instruction means for in response to a second one of said plurality of marketplaces receiving said information about said received order from said first one of said plurality of marketplaces, said second one determining whether said second one can match said received order with at least one order posted in a local order book maintained by said second one of said plurality of marketplaces; and
instruction means for in response to a determination that said second one of said plurality of marketplaces cannot match said received order, said second one of said plurality of marketplaces transmitting a notice to said first one of said plurality of marketplaces that no match exists.

58. The product according to claim 45, further comprising:
instruction means for in response to a second one of said plurality of marketplaces receiving said information about said received order from said first one of said plurality of marketplaces, said second one determining whether said second one can match said received order with at least one order posted in a local order book maintained by said second one of said plurality of marketplaces; and
instruction means for in response to a determination that said second one of said plurality of marketplaces can match said received order, said second one selecting all orders posted in said second one's local order book which match a product requested by said received order;
instruction means for said second one locking all of said selected orders; and
instruction means for said second one transmitting a notice to said first one, said notice including information about all of said selected orders.

59. The product according to claim 58, further comprising:
instruction means for said first one transmitting a specification of at least one of said selected orders to said second one;
instruction means in response to said second one has receiving a specification from said first one of said at least one of said selected orders:
for unlocking all of said selected orders;
for clearing said at least one of said selected orders specified by said first one; and
for said second one transmitting a confirmation to said first one that said at least one of said selected orders has been cleared.

60. The product according to claim 45, wherein said plurality of marketplaces includes a plurality of different individual on-line auction sites.

61. The product according to claim 45, wherein said instruction means for receiving an order further comprises instruction means for receiving an auction bid.

62. The product according to claim 45, wherein said instruction means for of receiving an order further comprises instruction means for receiving a reverse auction bid.

63. The product according to claim 45, wherein said instruction means for receiving an order further comprises instruction means for receiving a multi-sided auction bid.

64. The product according to claim 45, wherein said instruction means for receiving an order further comprises instruction means for receiving a call auction bid.

65. The product according to claim 45, further comprising instruction means for establishing each one of said plurality of marketplaces in a different computer system.

66. The product according to claim 45, further comprising instruction means for establishing each one of said plurality of marketplaces in a different one of a plurality of computer systems, wherein said plurality of computer systems are coupled together utilizing the Internet.
